(19) United States
(12) Patent Application Publication
(10) Pub. No.: US 2003/0072423 A1
(43) Pub. Date: Apr. 17, 2003

(54) Communication apparatus

(76) Inventor: Shinichi Momonami, Nara-shi (JP)

Correspondence Address: BIRCH STEWART KOLASCH & BIRCH, PO BOX 747, FALLS CHURCH, VA, 22040-0747, US

(21) Appl. No.: 10/247,538

(22) Filed: Sep. 20, 2002

(30) Foreign Application Priority Data
Sep. 21, 2001 (JP) P2001-289796

(51) Int. Cl. H04M 11/00

(52) U.S. Cl. 379/93.02; 379/93.03

(57) ABSTRACT

In a telephone which is connected to a public telephone network, data constellation which comprises telephone number to connect of an access point as a connection point to a communication system for connecting a transmission side and the receiving party through the Internet communication network from the public telephone network and a plurality of passwords for allowing utilization of the communication system are stored in RAM in association with a specific key operation such as an abbreviated dial, or an one-touch dial in a key input part, and in response to input of the specific key operation, the telephone number to connect is read out from RAM and sent out, and thereafter, any one of the plurality of passwords is read out from the RAM and sent out.

### BACKGROUND OF THE INVENTION

1. Field of the Invention

The present invention relates a communication apparatus, such as a telephone or a facsimile machine which are suitable on the occasion of utilizing a communication system in which, for example, like Internet telephone connection service, a plurality of access points for connecting a first communication line network and a second communication line network are set, and the plurality of access points can be connected by the second communication line network, and a communication apparatus of initiating party and the access point, and a communication apparatus of the receiving party and the access point, are connected by the first communication line network, respectively, and the two access points are connected by the second communication line network, so that a communication between the two communication apparatuses is carried out.

2. Description of the Related Art

Based upon the recent popularization of the Internet, a communication system for carrying out the Internet telephone connection service which enables international telephone calls and telecommunications with cheap rate has been popularized, and particularly, for example, in U.S., various pre-paid cards called as for example, calling cards for enjoying this connection service have been sold. The calling card, unlike the pre-paid card such as a telephone card, is a card on which a telephone number to connect of a connection service provider and a password necessary for utilizing the communication system are only displayed (printed). Accordingly, purchase of the calling card means purchase of the password, and purchase price becomes communication charge which is paid to the connection service provider. The connection service provider manages passwords and communication charges (also, referred to as number of calls), and at the request of a purchaser of a calling card (password), provides a connection service which corresponds to a communication charge.

A user who purchased a typical calling card can carry out a communication through the Internet by taking three steps which are the user (1) inputs telephone number to connect and is connected to the connection service provider (access point), (2) inputs a password (alphanumeric character of approximately 10 digits) which is described on the calling card, and (3) inputs telephone number of the receiving party. Accordingly, the user can enjoy the Internet telephone connection service by utilizing the calling card without entering into a special contract with the Internet service provider (ISP).

As stated above, in case of generally utilizing the calling card, it is necessary for the user to, before inputting the telephone number of the receiving party, input number of more than 20 digits by the telephone number to connect of the connection service provider and the password. Further, there may occur a case where connectivity of the connection service is deteriorated very much, because of concentrated requests at some time zone, and in such case, it is necessary for the user to reiterate the same operations again and again, until the user is connected to the receiving party.

Further, even in the case where the user has the same kind of and a plurality of calling cards, when validity of the calling card (password) which is being used runs out during a call, i.e., when the number of remaining calls in the calling card which is being used becomes zero, the connection is cut off, and therefore, in order to continue the call, it is necessary to input a password of another calling card freshly and use it. Furthermore, in case of utilizing the calling card, it is necessary to always have the calling card, or to make a quick short note of or memorize the password which is described on the calling card, and therefore, it is extremely disadvantageous in the case where one calling card is used in common by a plurality of users.

### SUMMARY OF THE INVENTION

An object of the invention is to provide a communication apparatus and a communication system which can improve operationality and convenience, on the occasion of utilizing a communication system which carries out a communication connection service through a communication line network which is different from a communication line network to which a communication apparatus is connected, like a telephone connection service by use of the Internet communication network.

The invention provides a communication apparatus connected to a first communication line network, comprising:

key input means for carrying out an input by a key operation;

memory means for storing data constellation which includes telephone number to connect of an access point as a connection point to a communication system which connects a communication apparatus of the initiating party and a communication apparatus of the receiving party through a second communication line network and a plurality of passwords for allowing utilization of the communication system, in association with a specific key operation in the key input means; and

control means, responsive to the input of the specific key operation, for reading out the telephone number to connect from the memory means and transmitting it and thereafter, for reading out any one of the plurality of passwords and transmitting it.

According to the invention, in the case where an operator carries out the specific key operation from the key input means, firstly telephone number to connect is sent out, and when connected to an access point, a password is sent out. The specific key operation may be, for example, one key operation like a one-touch dial key, and may be operations of several keys like abbreviated dial operations. In this way, it becomes possible to communicate through the communication system utilizing the second communication line network different from the first communication network line to which the communication apparatus is connecting. Hereby, it becomes unnecessary for the operator to operate numeric keys of digits which correspond to the telephone number to connect and the password for inputting them so that input errors are decreased and operationality is increased. Further, even in the case where connectivity with the communication system is bad and there is a necessity to carry out the input operation again, all that should be done is to carry out the specific key operation so that necessity for repeating complicated key operations is eliminated and burden to the operator is reduced.

Further, in the invention it is preferable that the control means, in response to an operation for deleting a password by the key input means, deletes the password which was designated by the password deleting operation from the memory means.

According to the invention, when an operator carries out the password deleting operation from the key input means, the password which is designated by the password deleting operation is deleted. This password deleting operation is carried out when validity of the password is expired. The operator can learn that the validity of the password is expired by a predetermined message from the communication system. Accordingly, on the occasion of carrying out communication by use of the communication system, there occurs no cases where an expired password is sent out and there occurs no cases where an operator carries out useless operations, so that operationality is improved.

Further, in the invention it is preferable that the control means, in response to an expiration report signal which is sent out from the access point when validity of a password which is received by the access point is expired, deletes the password which is sent out from the memory means.

According to the invention, when the expiration report signal from the access point is received after the password is sent out, the password which is sent out is deleted from the memory means. Accordingly, on the occasion of carrying out communication by use of the communication system, there occurs no cases where an expired password is sent out and there occurs no cases where an operator carries out useless operations so that operationality is improved. Further, since the password is automatically deleted, a necessity that an operator carries out an operation for deleting a password is eliminated so that burden to the operator is reduced and convenience is improved.

Further, in the invention it is preferable that the control means, in response to a pre-expiration report signal which is sent out from the access point when possible communication time by the password which is received by the access point becomes less than a predetermined threshold value during communication, deletes the password which is sent out from the memory means, after completion of the communication.

According to the invention, when the pre-expiration report signal is received from the access point during communication, the password which is sent out for communication is deleted from the memory means. Accordingly, on the occasion of carrying out communication by use of the communication system, there occurs no cases where an expired password is sent out and there occurs no cases where an operator carries out useless operations so that operationality is improved. Further, since the password is automatically deleted, a necessity that an operator carries out an operation for deleting a password is eliminated, so that burden to the operator is reduced and convenience is improved.

Further, in the invention it is preferable that the control means, in response to a password falseness signal which is sent out from the access point when a password which is received by the access point is false, reads out the same password from the memory means and sends out it again.

According to the invention, when the password falseness signal from the access point is received after the password is sent out, the same password is sent out again. By this password re-sending operation, it is possible to confirm whether or not the password is really false. This is because there may occur a case where a correct password can not be received by various factors, such as generation of noise or errors during sending out the password, or unstability of the first communication line network. Accordingly, there occurs no cases where an operator carries out the specific key operation repeatedly when the password is not accepted, so that operationality and convenience are improved and it is possible to prevent a correct password from being deleted accidentally.

Further, in the invention it is preferable that the control means, in responds to a password falseness signal which is sent out from the access point when a password which is received by the access point is false, deletes the password which is sent out from the memory means.

According to the invention, when the password falseness signal from the access point is received after the password is sent out, the password which is sent out is deleted from the memory means. Accordingly, on the occasion of carrying out communication by use of the communication system, there occurs no cases where an expired password is sent out and there occurs no cases where an operator carries out useless operations, so that operationality is improved. Further, since the password is automatically deleted, a necessity that an operator carries out an operation for deleting a password is eliminated, so that burden to the operator is reduced and convenience is improved.

Further, in the invention it is preferable that the control means deletes a password which is sent out from the memory means in the case where the password falseness signal which is sent out from the access point when a password which is received by the access point is false is successively received at predetermined number of times.

According to the invention, when the password falseness signal from the access point is received successively at predetermined number of times, the password which is sent out is deleted from the memory means. The reason why the password is deleted when the password falseness signal is received successively, is that there may occur a case where a correct password can not be received by various factors, such as generation of noise or errors during sending out the password, or unstablity of the first communication line network. Accordingly, there occurs no cases where a correct password is deleted accidentally so that convenience is improved.

Further, in the invention it is preferable that telephone number of the receiving party is stored in the memory means in association with dial transmission operation in the key input means, and the control means, when the dial transmission operation is inputted after a password is sent out, reads out the telephone number of the receiving party which is stored in association with the dial transmission operation from the memory means and sends it out.

According to the invention, in the case where an operator carries out the dial transmission operation from the key input means, after connection to the communication system is established by sending the password, the telephone number of the receiving party is sent out. The dial transmission operation may be, for example, one key operation like a one-touch dial key, and may be operations of several keys like an abbreviated dial operation. Hereby, it becomes unnecessary for the operator to operate numeric keys of digits which correspond to the telephone number of the receiving party for inputting it so that an input operation is simplified and operationality is increased.

Further, in the invention it is preferable that telephone number of the receiving party is stored in the memory means in association with dial transmission operation in the key input means, and the control means recognizes the telephone number of the receiving party which is sent out based upon the dial transmission operation, and in response to the specific key operation thereafter, sequentially sends out the telephone number to connect, the password, and the telephone number of the receiving party.

According to the invention, in the case where an operator carries out the dial transmission operation from the key input means and continuously, carries out the specific key operation, the telephone number to connect, the password, and the telephone number of the receiving party are sent out sequentially. The dial transmission operation may be, for example, one key operation like the one-touch dial key, and may be operations of several keys like the abbreviated dial operation. Hereby, it becomes unnecessary for the operator to operate numeric keys of digits which correspond to the telephone number of the receiving party on the occasion of inputting it, so that an input operation is simplified and operationality is increased.

Further, in the invention it is preferable by further comprising display means, and that the control means sends out the telephone number of the receiving party and displays the telephone number of the receiving party on the display means.

According to the invention, in the case where an operator carries out the dial transmission operation after the specific key operation, the telephone number of the receiving party is sent out and the telephone number of the receiving party is displayed. Hereby, the operator can confirm the receiving party of communication so that so-called misdial can be avoided.

Further, in the invention it is preferable by further comprising display means, and that the control means recognizes the telephone number of the receiving party and displays the telephone number of the receiving party on the display means.

According to the invention, in the case where an operator carries out the dial transmission operation in advance of the specific key operation, the telephone number of the receiving party is recognized by the control means and the telephone number of the receiving party is displayed. Hereby, the operator can confirm the receiving party of communication, so that so-called misdial can be avoided. Further, the receiving party of communication can be recognized before connection to the communication system, so that it becomes possible to save communication cost.

Further, in the invention it is preferable by further comprising display means, and that name of the receiving party is stored in the memory means together with telephone number of the receiving party, and the control means sends out the telephone number of the receiving party and displays the telephone number of the receiving party and/or name of the receiving party on the display means.

According to the invention, in the case where an operator caries out the dial transmission operation after the specific key operation, the telephone number of the receiving party is sent out and the telephone number of the receiving party and/or name of the receiving party are displayed. Hereby, the operator can confirm the receiving party of communication, so that so-called misdial can be avoided.

Further, in the invention it is preferable by further comprising display means and that name of the receiving party is stored in the memory means together with telephone number of the receiving party, and the control means recognizes the telephone number of the receiving party and displays the telephone number of the receiving party and/or name of the receiving party on the display means.

According to the invention, in the case where an operator carries out the dial transmission operation in advance of the specific key operation, the telephone number of the receiving party is recognized by the control means, and the telephone number of the receiving party and/or name of the receiving party are displayed. Hereby, the operator can recognize the receiving party of communication, so that so-called misdial can be avoided. Further, the receiving party of communication can be recognized before connection to the communication system, so that it becomes possible to save communication cost.

Further, in the invention it is preferable by further comprising notice means, and that the control means, when a password is deleted, drives the notice means to give the operator a notice of switching to a new password.

According to the invention, when a password is automatically deleted in response to a signal from the communication system, the notice means is driven to give the operator the notice of switching to the new password. Hereby, the operator can recognize a use situation of a password.

Further, in the invention it is preferable by further comprising notice means, and that the control means, when there occurs a case where only one password remains after the deletion of password, drives the notice means to give the operator a notice that only one password remains.

According to the invention, a password is automatically deleted in response to a signal from the communication system, and when there occurs a case where only one password remains after the deletion of password, the notice means is driven to give the operator a notice that only one password remains. Hereby, the operator can grasp approximate remaining communication possible time, and can register a new password additionally to the memory means by purchasing the new password, so that it is possible to smoothly utilize communication by use of the communication system.

Further, in the invention it is preferable that data constellation which is stored in the memory means includes telephone number of the receiving party, and the control means sends out the telephone number of the receiving party after telephone number to connect and password are sent out.

According to the invention, in the case where an operator carries out the specific key operation from the key input means, firstly, the telephone number to connect is sent out, and when connected to the access point, the password is sent out and when it becomes possible to communicate by the communication system, the telephone number of the receiving party is sent out. In this manner, a necessity for the operator to carry out numeric keys of digits which correspond to the telephone number to connect, the password and the telephone number of the receiving party for inputting them is eliminated, so that input errors are eliminated and operationality is improved. Further, even in the case where connectivity to the communication system is bad and the input operation has to be carried out again, all that should be done is to carry out the specific key operation, so that necessity for repeating complicated key operations is eliminated and burden to the operator is reduced.

Further, the invention provides a communication system comprising:

a communication apparatus of initiating party;

a communication apparatus of receiving party;

a first communication line network;

a second communication line network; and

a plurality of access points for connecting the first communication line network and the second communication line network, the plurality of access points being able to be connected by the second communication line network,

wherein the communication apparatus of initiating party and the access point, and the communication apparatus of receiving party and the access point are connected by the first communication line network, respectively, and the two access points are connected by the second communication line network so that a communication between the two communication apparatuses is carried out,

wherein when a predetermined password is inputted after connection is established to the access point from the communication apparatus of initiating party, a communication is made available, and

wherein a plurality of passwords can be inputted from the communication apparatus of initiating party to the access point.

According to the invention, since communication is maintained based upon the plurality of passwords, as compared with a case of communication based upon one password, long time communication becomes possible. Hereby, an operator can communicate without taking no thought of expiration time of validity of the password, so that convenience is improved.

Further, the invention provides a communication system comprising:

a communication apparatus of initiating party;

a communication apparatus of receiving party;

a first communication line network;

a second communication line network; and

a plurality of access points for connecting the first communication line network and the second communication line network, the plurality of access points being able to be connected by the second communication line network,

wherein the communication apparatus of initiating party and the access point, and the communication apparatus of receiving party and the access point are connected by the first communication line network, respectively, and the two access points are connected by the second communication line network so that a communication between the two communication apparatuses is carried out,

wherein when a predetermined password is inputted after connection is established to the access point from the communication apparatus of initiating party, a communication is made available, and

wherein when communication possible time by the password which is inputted becomes less than a predetermined threshold value during communication, the access point requires for an input of a password, and in the case where a new password is inputted from the communication apparatus of initiating party, even when the communication possible time by the initial password is expired, the communication is continued based upon the new password without disconnecting the communication.

According to the invention, in the case where the new password is inputted from the communication apparatus of initiating party, as for the input request of the password from the access point, even when the communication possible time by the initial password is expired, the communication is continued based upon the new password without disconnecting the communication. Hereby, even when the password is switched, the communication is not cut off, so that convenience is improved.

### BRIEF DESCRIPTION OF THE DRAWINGS

Other and further objects, features, and advantages of the invention will be more explicit from the following detailed description taken with reference to the drawings wherein:

FIG. 1 is a schematic view showing telephone connection procedures by a communication system utilizing the Internet communication network as one embodiment of the invention;

FIG. 2 is a schematic view showing an outline of the communication system utilizing the Internet communication network as one embodiment of the invention;

FIGS. 3A to 3E are sequence views showing sequences on the occasion of transmission in the communication system;

FIG. 4 is a block diagram showing a structure of a caller side telephone;

FIG. 5 is a plan view showing key layout in a key input part;

FIG. 6 is a flow chart for explaining operational procedures in case of registering telephone number to connect of an access point (connection service provider) and a plurality of passwords to the caller side telephone;

FIGS. 7A to 7C are views showing tables in which the telephone number to connect and the plurality of passwords are stored in association with each other to RAM of the telephone in accordance with the flow chart of FIG. 6;

FIG. 8 is a flow chart for explaining operational procedures when registering a password additionally;

FIG. 9 is a flow chart for explaining procedures in case of calling by utilizing a plurality of passwords;

FIG. 10 is a flow chart for explaining operational procedures in case of registering telephone number of the receiving party, name of the receiving party, telephone number to connect and a plurality of passwords in association with one another to the caller side telephone;

FIG. 11 is a flow chart for explaining procedures in case of carrying out a communication by use of a table registered along the procedures of the flow chart of FIG. 10; and

FIG. 12 is a schematic view for explaining other embodiment of the invention.

### DETAILED DESCRIPTION OF THE PREFERRED EMBODIMENTS

Now referring to the drawings, preferred embodiments of the invention are described below.

The present invention provides a communication apparatus in which an input operation of plural digits is registered and stored in the communication apparatus so that operation work of an operator is reduced, and operationality and convenience are improved.

A first feature is that one telephone number to connect in the same kind of and a plurality of calling cards and a plurality of password are associated with one another to be made as a table, and registered in an abbreviated dial or an one-touch dial, and by designating one of the associated table by the abbreviated dial key or the one-touch dial key in case of communication, a password is used from an initial password sequentially.

A second feature is handling in the case where validity (number of remaining calls) of one password is expired.

A third feature is handling in the case where a password which is sent out is false.

A fourth feature is that operationality is made to be improved on the occasion of sending out telephone number of the receiving party.

A fifth feature is that the receiving party of communication is made to be easily confirmed.

A sixth feature is that the telephone number of the receiving party, one telephone number to connect in the same kind of and a plurality of calling cards and a plurality of password are associated with one another to be made as a table, and registered in an abbreviated dial or an one-touch dial, and by designating one of the associated table by the abbreviated dial key or the one-touch dial key in case of communication, a connection to the receiving party is established.

The invention is applied to all of telephones, facsimile machines, communication apparatuses, information processing apparatuses or the like which are connected to a general public line as the first communication line network by wired connection (telephone line) or wireless connection, but here, a telephone which is wire-connected by the telephone line will be described, taking it as one example.

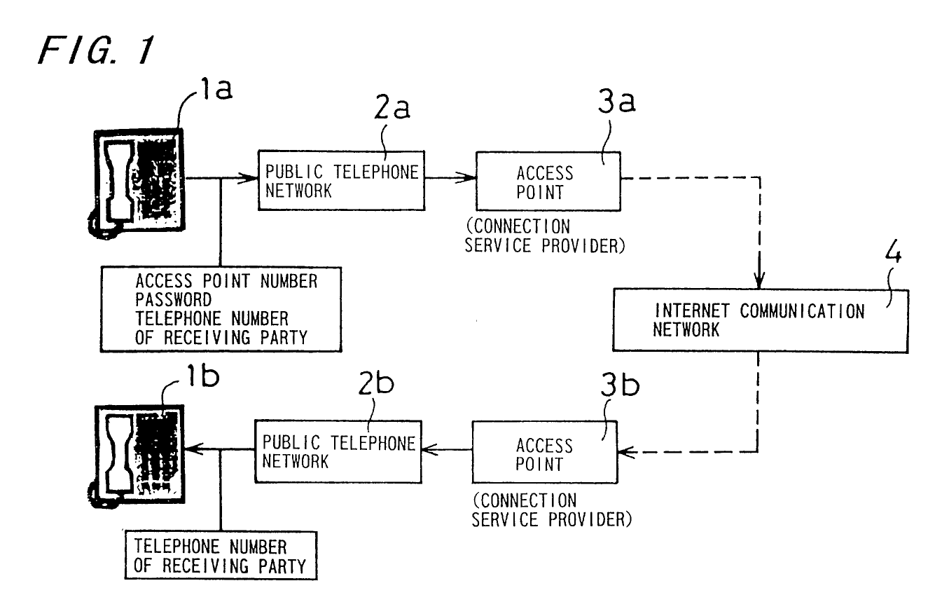

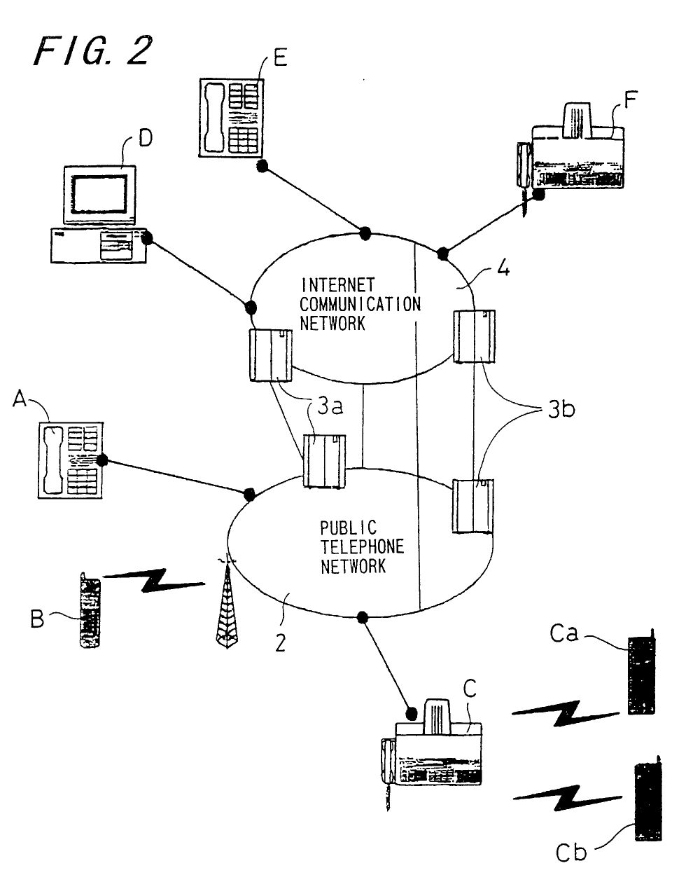

FIG. 1 is a schematic view showing telephone connection procedures by a communication system utilizing the Internet communication network 4 as one embodiment of the invention, and FIG. 2 is a schematic view showing an outline of the communication system utilizing the Internet communication network 4 as one embodiment of the invention. Firstly, in reference to FIG. 2, a telephone A, a portable telephone B, and a facsimile machine C having two cordless handsets Ca, Cb are connected to a public telephone network 2, and a computer D, a telephone E and a facsimile machine F are connected to the Internet communication network 4. The telephone A, the portable telephone B and the facsimile machine C are connected by the public telephone network 2 to enable communication. Further, the computer D, the telephone E and the facsimile machine F are connected by the Internet communication network 4 to enable communication. Furthermore, the telephone A, the portable telephone B, the facsimile machine C, the computer D, the telephone E, and the facsimile machine F are connected by the public telephone network 2, an access point 3 and the Internet communication network 4 to enable communication.

The communication system which utilizes the Internet communication network 4 is one utilizing a relation of connection shown in FIG. 2, and a plurality of access points 3a, 3b, . . . (reference mark “3” is used when called collectively) for connecting the public telephone network 2 as the first communication line network and the Internet communication network 4 as the second communication line network are set up, and the access points 3a and 3b can be connected by the Internet communication network 4, and for example, the telephone A as a communication apparatus of initiating party and the access point 3a, and for example, the portable telephone B as a communication apparatus of the receiving party and the access point 3b are connected by the public telephone network 2, respectively, and the two access points 3a and 3b are connected by the Internet communication network 4 to carry out communication between the two communication apparatuses A and B. Since this system utilizes the Internet communication network 4 which communication charge is cheaper than the public telephone network 2, communication charge in case of telecommunication, for example, in case of communication with a foreign country can be reduced.

In reference to FIG. 1, in the case where, by utilizing this communication system, a call is made from the caller side telephone 1a to a called side telephone 1b, the following connection procedures are followed. Firstly, an access point number (telephone number to connect) is inputted, and a connection is made to the access point (connection service provider) 3 which is designated by the calling card through the public telephone network 2, and subsequently, by sending out a password which is described on the calling card and telephone number of the receiving party, a connection is made to the other access point 3b through the Internet communication network 4, and the called side telephone 1b is called out from the other access point 3a through the public telephone network 2b so that communication is carried out. In addition, the called side telephone 1 which is used in the embodiment is assumed to have an abbreviated dialing function, or an one-touch dialing function, or equivalent function thereof.

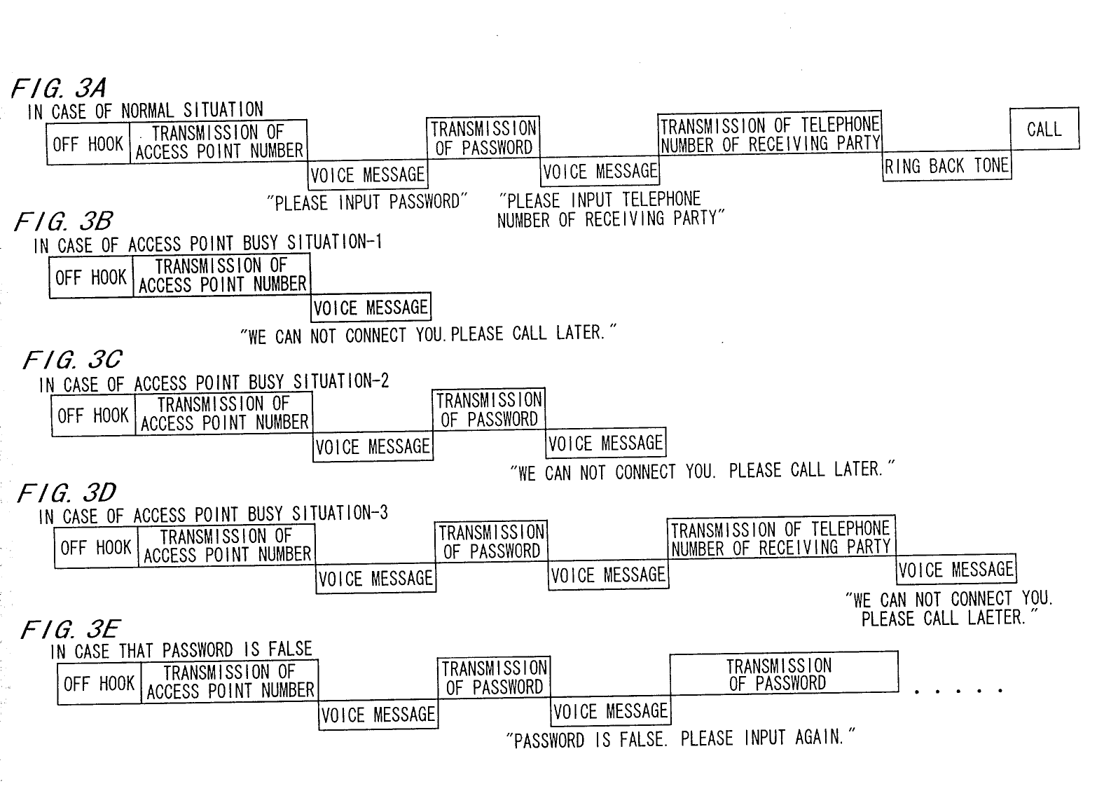

FIGS. 3A to 3E are sequence views showing sequences on the occasion of transmission in the communication system. FIG. 3A shows a sequence in case of a normal situation. Firstly, in the caller side telephone 1a, an operator takes the handset off the hook or the like to make an off-hook situation, and then, transmits the access point number. In case of being connected to the access point 3a, a voice message of for example, “Please input a password.” is sent out from the access point 3a. In response to this voice message, the operator transmits a predetermined password from the caller side telephone 1a. At this time, the communication system may be configured that a plurality of passwords can be inputted. In the case where the password is valid, from the access point 3a, a voice message of for example, “Please input telephone number of the receiving party.” is sent out. In response to this voice message, the operator transmits the telephone number of the receiving party from the caller side telephone 1a. Thereafter, ring back tone for calling out the called side telephone 1b is sent out, and when a user of the called side telephone 1b takes the handset, a call is started.

In addition, the call is cut off when communication possible time based upon a password which is inputted initially, but the communication system may be configured so that the communication possible time by the inputted password becomes less than a predetermined threshold value during communication, the access point 3a requests for an input of a password, and in the case where a new password is inputted from the telephone 1a, even when the communication possible time by the initial password is expired, the communication is continued based upon the new password without disconnecting the communication.

FIG. 3B shows a first sequence in the case where the access point 3a is in a busy situation. Firstly, at the caller side telephone 1a, the operator takes the handset off the hook or the like to make an off-hook situation, and transmits the access point number. From the access point 3a, a voice message of for example, “We can not connect you at present. Please call later.” is sent out.

FIG. 3C shows a second sequence in the case where the access point 3a is in a busy situation. Firstly, at the caller side telephone 1a, the operator takes the handset off the hook or the like to make an off-hook situation, and transmits the access point number. In case of being connected to the access point 3a, a voice message of for example, “Please input a password.” is sent out from the access point 3a. In response to this voice message, the operator transmits a predetermined password from the caller side telephone 1a. From the access point 3a, a voice message of for example, “We can not connect you. Please call later.” is sent out.

FIG. 3D shows a third sequence in the case where the access point 3a is in a busy situation. Firstly, at the caller side telephone 1a, the operator takes the handset off the hook or the like to make an off-hook situation, and transmits the access point number. In case of being connected to the access point 3a, a voice message of for example, “Please input a password.” is sent out from the access point 3a. In response to this voice message, the operator transmits a predetermined password from the caller side telephone 1a. In the case where the password is valid, from the access point 3a, a voice message of for example, “Please input telephone number of the receiving party.” is sent out. In response to this voice message, the operator transmits the telephone number of the receiving party from the caller side telephone 1a. From the access point 3a, a voice message of for example, “We can not connect you. Please call later.” is sent out.

FIG. 3E shows a sequence in the case where a password is false. Firstly, at the caller side telephone 1a, the operator takes the handset off the hook to make an off-hook situation, and transmits the access point number. In case of being connected to the access point 3a, a voice message of for example, “Please input a password.” is sent out from the access point 3a. In response to this voice message, the operator transmits a predetermined password from the caller side telephone 1a. In the case where the password is false, a voice message of for example, “The password is false. Please input again.” is sent out. In response to this voice message, the operator transmits the predetermined password again from the caller side telephone 1a. In the case where the password is correct, the sequence goes to an input sequence of number of the receiving party, and in the case where the password is false, after this password input sequence is repeated at predetermined number of times, a connection is rejected.

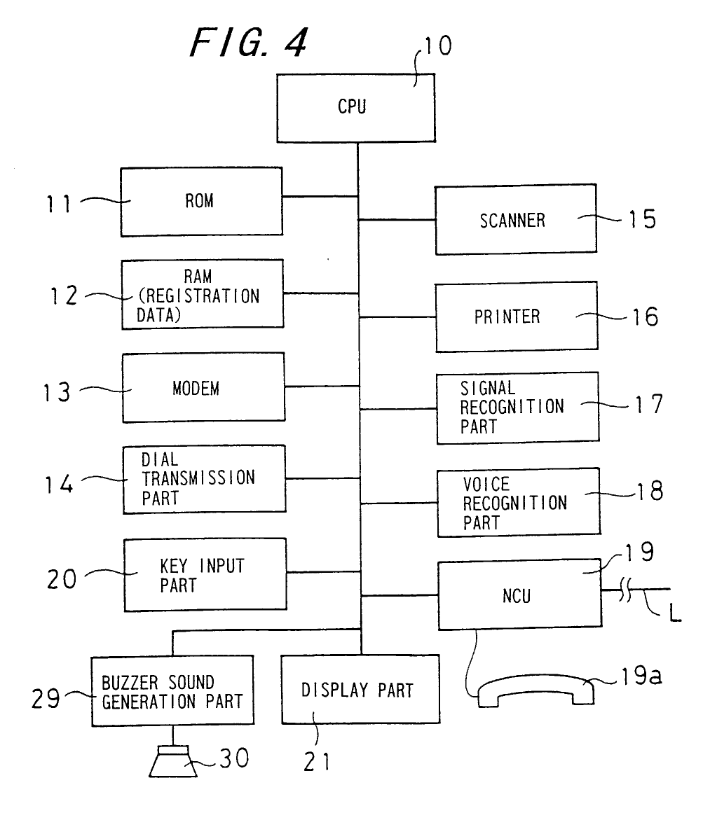

Further, the telephone 1a may carry out re-transmission of the password automatically. That is, it may be configured that, in response to a password falseness signal from the access point 3a, the same password is read out from a RAM 12 which will be shown in FIG. 4 later and then, transmitted again. By this password re-transmission operation, it is possible to confirm whether or not the password is really false. This is because there may occur a case where a correct password can not be received by various factors, such as time that noise and errors are generated when the password is sent out, or time that the public telephone network 2 is unstable. Accordingly, there occurs no cases where an operator carries out the key operation repeatedly when the password is not accepted so that operationality and convenience are improved and it is possible to prevent a correct password from being deleted accidentally.

Further, when the password falseness signal from the access point 3a is received after the password is sent out, the password which is sent out may be deleted from the RAM 12. Hereby, on the occasion of carrying out communication by use of the communication system, there occurs no cases where an expired password is sent out and there occurs no cases where an operator carries out useless operations so that operationality is improved. Further, since the password is automatically deleted, a necessity that an operator carries out an operation for deleting a password is eliminated so that burden to the operator is reduced and convenience is improved.

Furthermore, when the password falseness signal from the access point 3a is successively received at predetermined number of times, the password which is sent out may be deleted from the RAM 12. The reason that the password is deleted when the password falseness signal is received successively is that there may occur a case where a correct password can not be received by various factors, such as time that noise or errors are generated when the password is sent out, or time that the public telephone network 2 is unstable. Accordingly, there occurs no cases where a correct password is deleted accidentally so that convenience is improved.

FIG. 4 is a block diagram showing a structure of a caller side telephone 1a. The telephone 1a has a facsimile communication function. The telephone 1a is configured by including a CPU (Central Processing Unit) 10, a ROM (Read Only Memory) 11, the RAM (Random Access Memory) 12, a modem 13, a dial transmission part 14, a scanner 15, a printer 16, a signal recognition part 17, a voice recognition part 18, an NCU (Network Control Unit) 19, a key input part 20, a display part 21, and a buzzer sound generation part 29.

The CPU 10 controls operation of the entire telephone 1a. The ROM 11 stores a program necessary for control of the telephone 1a, various parameters or the like, and the CPU 10 controls operations based upon memory content of the ROM 11. The RAM 12 stores various registration data which is registered by the operator, and the registration data includes telephone numbers to connect, passwords and telephone numbers of other parties, which will be described later.

The modem 13 modulates and demodulates image signals in a facsimile communication. The dial transmission part 14, in response to an operation of the key input part 20 which will be described later, transmits dialing pulses or tone signals for calling. The scanner 15 reads out a manuscript to be sent by the facsimile communication and converts it into the image signal. The printer 16 prints out the image signal which is received by the facsimile communication on a recording paper.

The signal recognition part 17 recognizes kind of a signal which is sent out from the access point 3, and sends out the result of recognition to the CPU 10. The voice recognition part 18 recognizes a voice message which is sent out from the access point 3, and sends out the result of recognition to the CPU 10. The NCU 19 is connected to the public telephone network 2 through a telephone line L, and controls the public telephone network 2, and enable a call through a handset 19a.

The key input part 20, although the details will be described later, has a plurality of keys for operating the telephone 1a, and is operated by the operator. The display part 21 displays an operational situation of the telephone la, input contents from the key input part 20 and the like. The buzzer sound generation part 29 generates a various buzzer sound and outputs the sound from a speaker 30. Hereby, the operator is noticed with the operational situation or the like of the telephone 1a.

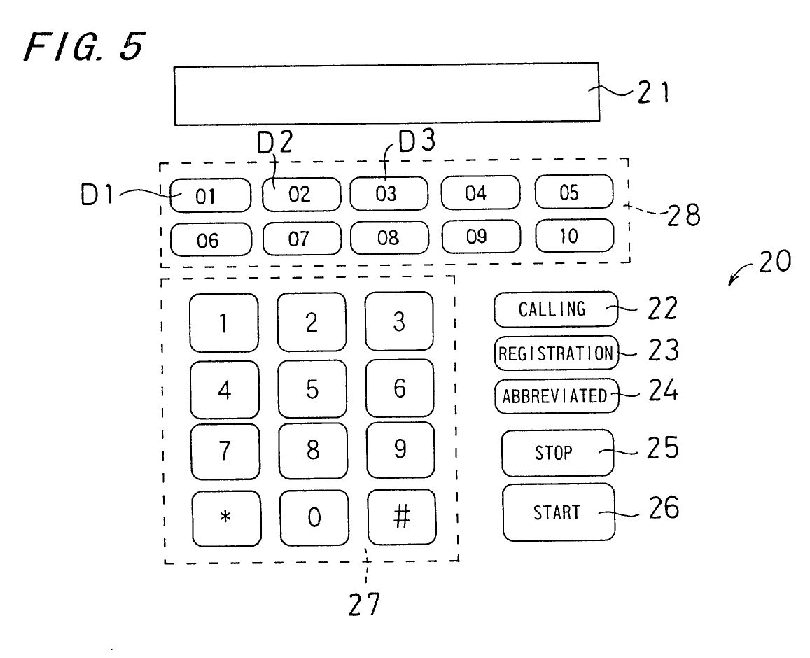

FIG. 5 is a plan view showing key layout in a key input part 20. The key input part 20 is disposed at a lower side of the display part 21, and has a calling key 22, a registration key 23, an abbreviation key 24, a stop key 25, a start key 26, and numeric keys 27. The calling key 22 is used when making a call. The registration key 23 is used when various data such as telephone number to connect, password, telephone number of the receiving party or the like are registered. The abbreviation key 24 is used when the abbreviated dialing operation is carried out. The stop key 25 is used when stopping processing and operations in execution. The start key 26 is used when starting processing and operations. The numeric keys 27 are used when inputting numeric such as telephone number and password. In addition, the numeric keys 27 include an asterisk key and a sharp key. The one-touch dialing key 28 is used on the occasion of sending out telephone number by the one-touch dialing operation.

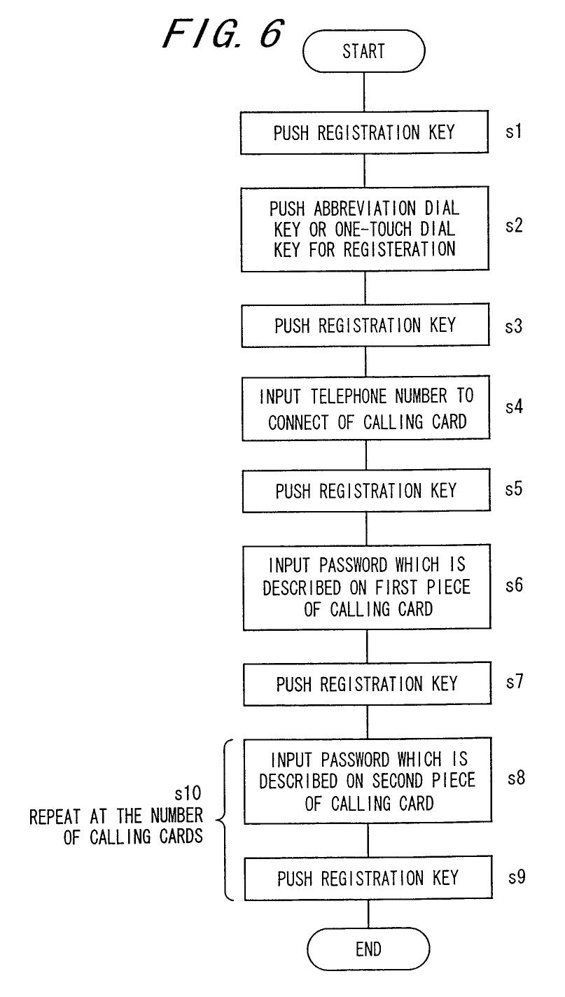

FIG. 6 is a flow chart for explaining operational procedures in case of registering and storing telephone number to connect of an access point (connection service provider) 3 designated in the same kind of and a plurality of calling cards and a plurality of passwords designated in the same kind of a plurality of calling cards to the caller side telephone 1a.

Firstly, at step s1, by pushing the registration key 23, a registration mode is set. Subsequently, at step s2, the abbreviation dial key or the one-touch dial key for registering data in the same kind of and a plurality of calling cards is selected from the key input part 20, and registered at step s3 by pushing the registration key 23. Subsequently, at step s4, telephone number to connect of a connection service provider (access point 3) which is designated in the same kind of and a plurality of calling cards is inputted, and registered at step s5 by pushing the registration key 23.

Subsequently, at step s6, a password which is described on a first piece of a calling card among the same kind of and a plurality of calling cards is inputted by the numeric keys 27 or the like, and registered at step s7 by pushing the registration key 23. Subsequently, at step s8, a password which is described on a second piece of a calling card among the same kind of and a plurality of calling cards is inputted by the numeric keys 27 or the like, and registered at step s9 by pushing the registration key 23. Hereinafter, at step s10, the same operation is repeated at number of the calling cards sequentially so that the registration is completed.

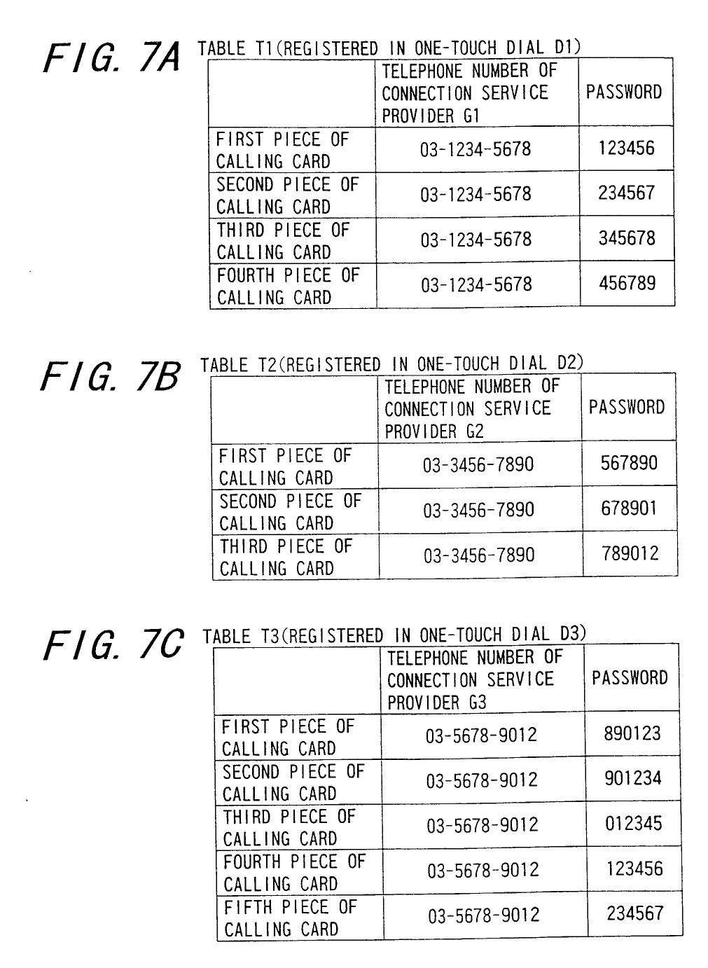

FIGS. 7A to 7C are one example of tables T1 through T3 (reference mark “T” is used when called collectively) in which the telephone numbers to connect and the passwords of the same kind of and a plurality of calling cards, i.e., a plurality of calling cards for the same connection service provider are registered and stored in the RAM 12 of the telephone 1a in association with each other in accordance with the flow chart of FIG. 6. Here, the tables T1 through T3 of a first connection service provider G1 through a third connection service provider G3 are registered in one-touch dial keys D1 through D3, respectively.

In addition, a password which validity (remaining number of calls) is expired by calls of a user is deleted from these tables T1 through T3 sequentially. As for the deletion of the password, a password which is designated may be deleted from the RAM 12, in response to a predetermined password deletion operation which an operation carries out from the key input part 20. This password deletion operation is carried out when validity of the password is expired. The operator can learn that validity of the password is expired by a predetermined message from the communication system. Accordingly, on the occasion of carrying out communication by use of the communication system, there occurs no cases where an expired password is sent out and there occurs no cases where an operator carries out useless operations so that operationality is improved.

Further, in the case where an expiration notice signal is sent out when validity of a password which is accepted by the access point 3a is expired, the telephone 1a may delete the password automatically. In this case, the CPU 10 may be configured that, in response to the expiration notice signal which is received, the password which is sent out is deleted from the RAM 12. Hereby, on the occasion of carrying out communication by use of the communication system, there occurs no cases where an expired password is sent out and there occurs no cases where an operator carries out useless operations so that operationality is improved. Further, since the password is automatically deleted, a necessity that an operator carries out an operation for deleting a password is eliminated so that burden to the operator is reduced and convenience is improved.

Further, in the case where the access point 3a, when possible communication time by the password which is received becomes less than a predetermined threshold value during communication, sends out a pre-expiration report signal, in response to the pre-expiration report signal, the password which is sent out may be deleted from the RAM 12, after completion of the communication.

When a password is automatically deleted, to be switched to a new password may be noticed to an operator. As the notice means, the display part 21 and the buzzer sound generation part 29 may be used. The operator can learn to be switched to the new password by the display part 21 and the buzzer sound generation part 29. Hereby, the operator can grasp a use situation of a password.

Further, when there occurs a case where only one password remains after the deletion of password, the display part 21 and the buzzer sound generation part 29 may give the operator a notice that only one password remains. Hereby, the operator can grasp approximate remaining communication possible time, and can register additionally to the memory means by purchasing a new password so that it is possible to smoothly utilize communication by use of the communication system.

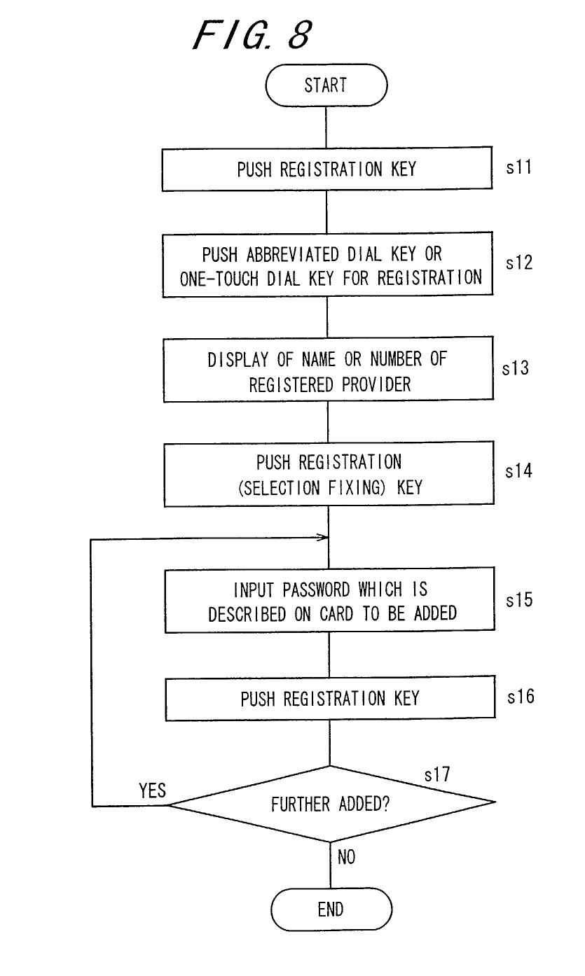

Furthermore, in the case where a password of the same kind of calling card is added to be registered, it is added to the same kind of tables T1 through T3. FIG. 8 is a flow chart for explaining operational procedures when registering a password additionally. Firstly, at step s11, the registration key 23 is pushed to set the registration mode. Then, at step s12, the abbreviated dial key or the one-touch dial key is pushed to carry out an additional registration, and at step s13, name of a connection service provider which has been registered or telephone number to connect is displayed on the display part 21. The operator confirm the table for registration by taking a look at this display content, and at step s14, pushes the registration key 23 to fix the selection. Subsequently, at step s15, a password which is described in a calling card to be added is inputted from the numeric keys 27, and at step s16, registered by pushing the registration key 23. At step s17, further, whether or not a password should be added is judged, and in case of addition, operations of steps s15 and s16 are carried out. The operation is completed when the password is not added.

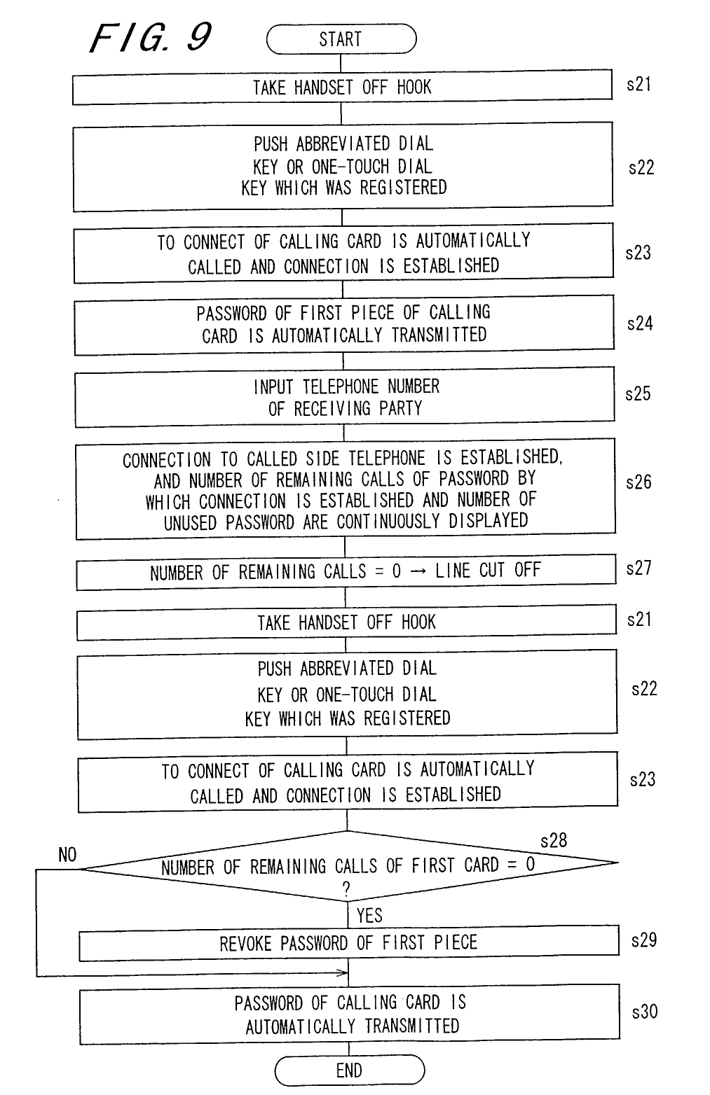

FIG. 9 is a flow chart for explaining procedures of when, in the case where a call is carried out by use of the same kind of and a plurality of calling cards, telephone numbers to connect of the access point (connection service provider) 3 which is registered in advance and recorded in the caller side telephone 1a based upon the flow chart of FIG. 6 or FIG. 8 and is designated in the same kind of and the plurality of calling cards and passwords are automatically switched to be sent, and further, telephone number of the receiving party is sent out so that a call is carried out.

Firstly, after at step s21, an operator takes the handset 19a off the hook, at step s22, the abbreviated dial key or the one-touch dial key by which data of the calling card is registered is pushed to be selected. Hereby, at step s23, telephone number to connect of a connection service provider which is designated in the calling card is automatically called so that a connection to the access point 3 is established. Subsequently, at step s24, a password which is described in a first piece of the same kind of and the plurality of calling cards is sent out. Then, the operator, at step s25, inputs telephone number of the receiving party by the numeric keys 27 or the like, or the abbreviated dial key, the one-touch dial key or the like by which telephone number of the receiving party has been already registered. Hereby, at step s26, a connection to the called side telephone 1b is established, and the number of remaining calls (based upon execution of a call, it is subtracted sequentially and displayed continuously) of the password which is using and the number of unused passwords are displayed. This call is possible with the remaining number of calls of the password on the first piece of the same kind of and the plurality of calling cards, and at the time point that the number of remaining calls of the password is consumed, the connection is cut off.

The information relating to the remaining number of calls is sent from the access point 3a. In the case where this information is a data signal, it is recognized by the signal recognition part 17, and in the case where this information is a voice signal, it is recognized by the voice recognition part 18, and the result of recognition is given to the CPU 10. The CPU 10 displays the result of recognition on the display part 21.

In addition, when telephone number of the receiving party is sent out, the telephone number of the receiving party may be displayed on the display part 21. Further, together with the telephone number of the receiving party, name of the receiving party may be registered in the RAM 12 and at least one of the telephone number of the receiving party and the name of the receiving party may be displayed.

Thereafter, in the case where a call is carried out by using a calling card of an identical connection service provider again, procedures of the steps s21 through s23 are to be repeated, but at step s28, since the number of calls of the password in the first piece is judged to be 0, the caller side telephone 1a revokes the password at step s29, and at step s30, sends out a password which is described on the second piece of the same kind of and the plurality of calling cards automatically. In addition, in the case where at step s28, the number of calls of the password of the first piece is judged not to be 0, this password, without being revoked, sends out at step s30.

In addition, in the flow chart of FIG. 9, telephone number of the receiving party is to be inputted after the password is sent out, but, in advance, the telephone number of the receiving party may be inputted by the abbreviated dial key or the like and recognized by the CPU 10 and thereafter, an operation for sending out the telephone number to connect and the password may be carried out by the abbreviated dial key or the like. Further, when the telephone number of the receiving party is recognized by the CPU 10, the telephone number of the receiving party may be displayed on the display part 21. Furthermore, together with the telephone number of the receiving party, name of the receiving party may be registered in the RAM 12 and at least one of the telephone number of the receiving party and the name of the receiving party may be displayed.

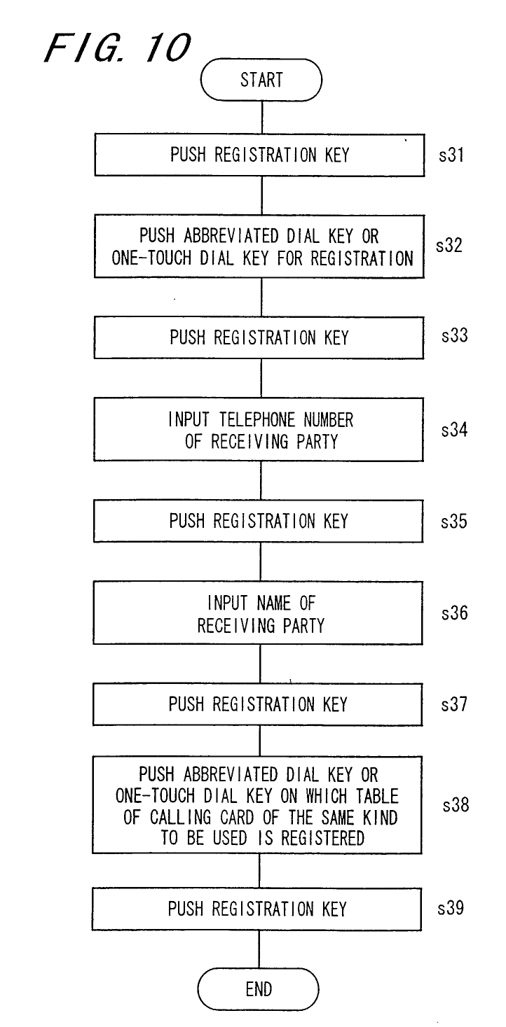

FIG. 10 is a flow chart for explaining operational procedures in case of registering and storing telephone number of the receiving party, name of the receiving party, telephone number to connect of a connection service provider as the access point 3 which is designated on the same kind of and the plurality of calling cards and a password which is described on the same kind of and the plurality of calling cards in association with one another to the caller side telephone 1a. Firstly, an operator, at step s31, pushes the registration key 23 to set a registration mode. Subsequently, the operator, at step s32, pushes the abbreviated dial key or the one-touch dial key for registering the various data to select, and at step s33, it is fixed by pushing the registration key 23. Subsequently, the operator, at step s34, pushes telephone number of the receiving party by the numeric keys 27, and at step s35, pushes the registration key 23 to register. Subsequently, the operator, at step s36, inputs name of the receiving party from the key input part 20, and at step s37, pushes the registration key 23 to register. Subsequently, the operator, at step s38, pushes the abbreviated dial key or the one-touch dial key in which any one of the tables T1 through T3 shown in FIG. 7 is registered, and lastly, at step s39, pushes the registration key 23 so that the registration is completed.

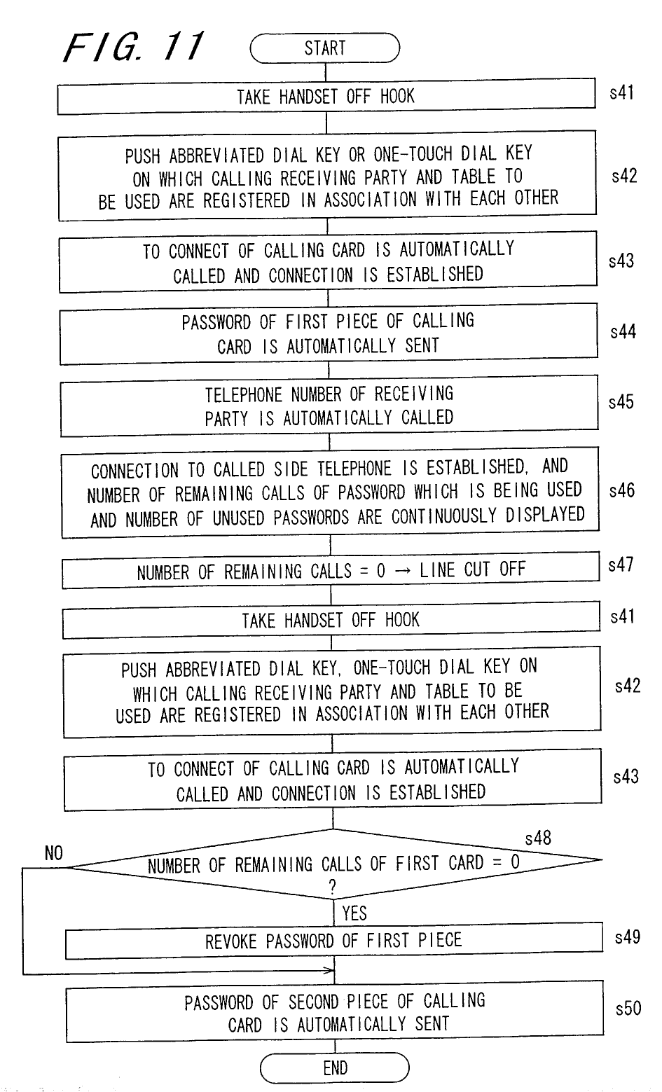

FIG. 11 is a flow chart for explaining procedures in case of carrying out an effective communication with a simple operation, by selecting the abbreviated dial key or the one-touch dial key, which is registered in association with a table in which telephone number of the receiving party, name of the receiving party, telephone number to connect of a connection service provider as the access point 3 which is designated in the same kind of and the plurality of calling cards and a password are registered in accordance with the procedures of the flow chart of FIG. 10, and by using the same kind of calling cards suitable to the communication with the receiving party to be called.

Firstly, at step s41, an operator takes the handset 19a off the hook, and at step s42, selects any one of the abbreviated dial key and the one-touch dial key which is registered in association with the receiving party and the table T to be used, in accordance with the flow chart of FIG. 10. Hereby, telephone number to connect of a connection service provider which is designated in a calling card which is selected at step s43 is automatically called, and then, at step s45, a password which is described in a first piece of the same kind of and the plurality of calling cards is sent out, and further, at step s45, the telephone number of the receiving party is automatically called. Hereby, at step s46, the caller side telephone 1a is connected to the called side telephone 1b, and the number of remaining calls (based upon execution of calls, it is subtracted sequentially and displayed continuously) of a card which password is used and the number of unused passwords on the table are displayed on the display part 21. This call is possible with the number of remaining calls on the first piece of the same kind of and the plurality of calling cards, and at the time point that the remaining number of calls of the calling cards is consumed, the connection is cut off.

Thereafter, in the case where a call is carried out by using a calling card of an identical connection service provider again, procedures of the steps s41 through s43 are to be repeated, but at step s48, since the number of calls of the password in the first piece is judged to be 0, the caller side telephone 1a revokes the password at step s49, and at step s50, sends out a password which is described on the second piece of the same kind of and the plurality of calling cards automatically. In addition, in the case where at step s48, the number of calls of the password of the first piece is judged not to be 0, this password, without being revoked, sends out at step s50.

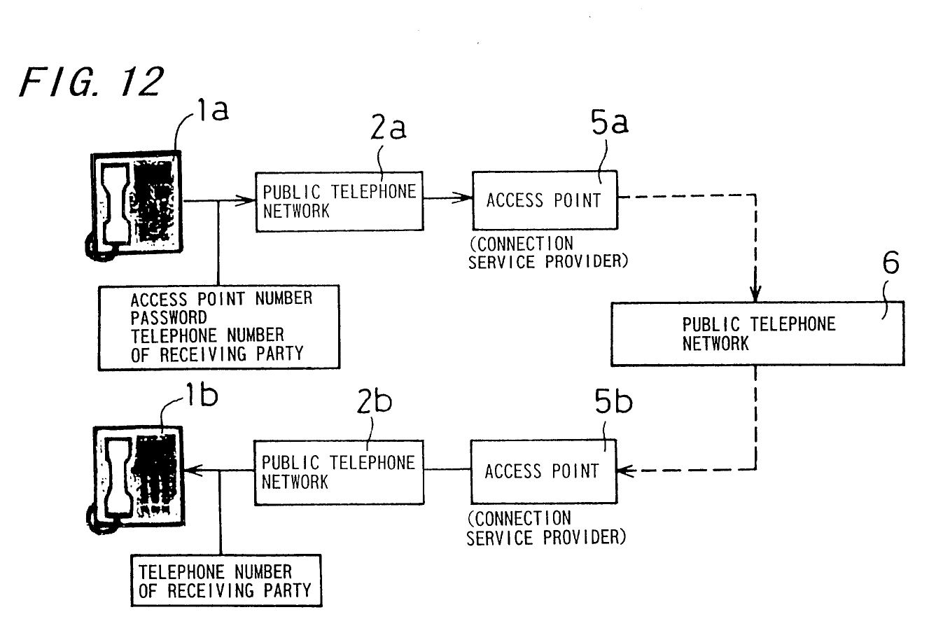

In the foregoing explanation, it was explained by taking the case of the communication system utilizing the Internet communication network 4 as an example, but, as shown in FIG. 12, it may be carried out in the same manner even in case of a communication system utilizing other public telephone network 6 which is connected to the public telephone lines 2a and 2b through the access points 5a and 5b.

As described above, according to the embodiment, in the case where an operator carries out the abbreviated dialing operation or the one-touch dialing operation as the specific key operation from the key input part 20, firstly, telephone number to connect is sent out, and when being connected to the access point 3, a password is sent out so that a communication by use of the communication system using the Internet communication network 4 different from the public telephone network 2 to which the caller side telephone 1a is connected becomes possible. In this manner, since a necessity that the operator operates the numeric keys 27 with digits of telephone number to connect and a password for inputting them is eliminated, an input error is eliminated and operationality is improved. Further, even in the case where connectivity to the communication system is bad and there is a necessity to carry out the input operation again, all that should be done is to carry out the specific key operation so that necessity for repeating complicated key operations is eliminated and burden to the operator is reduced.

Further, since, when an operator carries out a password deletion operation from the key input part 20, the password which is designated is deleted by the password deletion operation, on the occasion of carrying out a communication by use of the communication system, there occurs no cases where an expired password is sent out and thereby, there occurs no cases where an operator carries out useless operations so that operationality is improved.

Furthermore, since, when the expiration report signal from the access point 3 is received after the password is sent out, the password which is sent out is deleted from the RAM 12, on the occasion of carrying out communication by use of the communication system, there occurs no cases where an expired password is sent out and there occurs no cases where an operator carries out useless operations so that operationality is improved. Further, since the password is automatically deleted, a necessity that an operator carries out an operation for deleting a password is eliminated so that burden to the operator is reduced and convenience is improved.

Moreover, since, when the pre-expiration report signal is received from the access point 3 during communication, the password which is sent out for the communication is deleted from the RAM 12, on the occasion of carrying out communication by use of the communication system, there occurs no cases where an expired password is sent out and there occurs no cases where an operator carries out useless operations so that operationality is improved. Further, since the password is automatically deleted, a necessity that an operator carries out an operation for deleting a password is eliminated so that burden to the operator is reduced and convenience is improved.

Further, since, when the password falseness signal from the access point 3 is received after the password is sent out, the same password is sent out again, it is possible to confirm whether or not the password is really false. Accordingly, there occurs no cases where an operator carries out the specific key operation repeatedly when the password is not accepted so that operationality and convenience are improved and it is possible to prevent a correct password from being deleted accidentally.

Furthermore, since, when the password falseness signal from the access point 3 is received after the password is sent out, the password which is sent out is deleted from the RAM 12, on the occasion of carrying out communication by use of the communication system, there occurs no cases where an expired password is sent out and there occurs no cases where an operator carries out useless operations so that operationality is improved. Further, since the password is automatically deleted, a necessity that an operator carries out an operation for deleting a password is eliminated so that burden to the operator is reduced and convenience is improved.

Moreover, since, when the password falseness signal from the access point 3 is received successively at predetermined number of times, the password which is sent out is deleted from the RAM 12, there occurs no cases where a correct password is deleted accidentally so that convenience is improved.

Further, in the case where an operator carries out the dial transmission operation from the key input part 20 after connection to the communication system is established by sending out the password, the telephone number of the receiving party is sent out and therefore, in the case where the operator inputs telephone number of the receiving party, it becomes unnecessary for the operator to operate numeric keys 27 of digits which correspond to the telephone number of the receiving party so that an input operation is simplified and operationality is increased.

Furthermore, in the case where an operator carries out the dial transmission operation from the key input part 20 and continuously, carries out the specific key operation, the telephone number to connect, the password, and the telephone number of the receiving party are sent out sequentially, and therefore, in the case where the operator inputs the telephone number of the receiving party, it becomes unnecessary for the operator to operate numeric keys 27 of digits which correspond to the telephone number of the receiving party so that an input operation is simplified and operationality is increased.

Moreover, in the case where an operator carries out the dial transmission operation after the specific key operation, the telephone number of the receiving party is sent out and the telephone number of the receiving party is displayed and thereby, the operator can confirm the receiving party of communication so that so-called misdial can be avoided.

Further, in the case where an operator carries out the dial transmission operation in advance of the specific key operation, the telephone number of the receiving party is recognized by the CPU 10 and the telephone number of the receiving party is displayed and thereby, the operator can confirm the receiving party of communication so that so-called misdial can be avoided. Further, the receiving party of communication can be recognized before connection to the communication system so that it becomes possible to save communication cost.

Furthermore, in the case where an operator carries out the dial transmission operation after the specific key operation, the telephone number of the receiving party is sent out and the telephone number of the receiving party and/or name of the receiving party are displayed and thereby, the operator can recognize the receiving party of communication so that so-called misdial can be avoided.

Moreover, in the case where an operator carries out the dial transmission operation in advance of the specific key operation, the telephone number of the receiving party is recognized by the CPU 10, and the telephone number of the receiving party and/or name of the receiving party are displayed and thereby, the operator can recognize the receiving party of communication so that so-called misdial can be avoided. Further, the receiving party of communication can be recognized before connection to the communication system so that it becomes possible to save communication cost.

Further, when a password is automatically deleted in response to a signal from the communication system, switching to a new password is noticed to the operator by the display and/or the buzzer sound, and thereby, the operator can recognize a use situation of a password.

Furthermore, when there occurs a case where only one password remains after the automatic deletion of password in response to a signal from the communication system, a notice that only one password remains is given to the operator by the display and/or the buzzer sound, and thereby, the operator can grasp approximate remaining communication possible time, and can register additionally to the RAM 12 by purchasing a new password so that it is possible to smoothly utilize communication by use of the communication system.

Moreover, in the case where an operator carries out the specific key operation from the key input part 20, firstly, the telephone number to connect is sent out, and when connected to the access point 3, the password is sent out and when it becomes possible to communicate by the communication system, the telephone number of the receiving party is sent out, and thereby, a necessity for the operator to carry out numeric keys 27 of digits which correspond to the telephone number to connect, the password and the telephone number of the receiving party for inputting them is eliminated so that input errors are eliminated and operationality is improved. Further, even in the case where connectivity to the communication system is bad and the input operation has to be carried out again, all that should be done is to carry out the specific key operation so that necessity for repeating complicated key operations is eliminated and burden to the operator is reduced.

Further, since communication is maintained based upon the plurality of passwords, as compared with a case of communication based upon one password, long time communication becomes possible and thereby, an operator can communicate without taking no thought of expiration time of validity of the password so that convenience is improved.

Furthermore, in the case where the new password is inputted from the communication apparatus of initiating party, as for the input request of the password from the access point 3, even when the communication possible time by the initial password is expired, the communication is continued based upon the new password without disconnecting the communication and thereby, even when the password is switched, the communication is not cut off so that convenience is improved.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A communication apparatus connected to a first communication line network, comprising:
key input means for carrying out an input by a key operation;
memory means for storing data constellation which includes telephone number to connect of an access point as a connection point to a communication system which connects a communication apparatus of the initiating party and a communication apparatus of the receiving party through a second communication line network and a plurality of passwords for allowing utilization of the communication system, in association with a specific key operation in the key input means; and
control means, responsive to the input of the specific key operation, for reading out the telephone number to connect from the memory means and transmitting it and thereafter, for reading out any one of the plurality of passwords and transmitting it.

2. The communication apparatus of claim 1, wherein the control means, in response to an operation for deleting a password by the key input means, deletes the password which was designated by the password deleting operation from the memory means.

3. The communication apparatus of claim 1, wherein the control means, in response to an expiration report signal which is sent out from the access point when validity of a password which is received by the access point is expired, deletes the password which is sent out from the memory means.

4. The communication apparatus of claim 1, wherein the control means, in response to a pre-expiration report signal which is sent out from the access point when possible communication time by the password which is received by the access point becomes less than a predetermined threshold value during communication, deletes the password which is sent out from the memory means, after completion of the communication.

5. The communication apparatus of claim 1, wherein the control means, in response to a password falseness signal which is sent out from the access point when a password which is received by the access point is false, reads out the same password from the memory means and sends out it again.

6. The communication apparatus of claim 1, wherein the control means, in response to a password falseness signal which is sent out from the access point when a password which is received by the access point is false, deletes the password which is sent out from the memory means.

7. The communication apparatus of claim 1, wherein the control means deletes a password which is sent out from the memory means in the case where the password falseness signal which is sent out from the access point when a password which is received by the access point is false is successively received at predetermined number of times.

8. The communication apparatus of claim 1, wherein that telephone number of the receiving party is stored in the memory means in association with dial transmission operation in the key input means, and the control means, when the dial transmission operation is inputted after a password is sent out, reads out the telephone number of the receiving party which is stored in association with the dial transmission operation from the memory means and sends it out.

9. The communication apparatus of claim 1, wherein telephone number of the receiving party is stored in the memory means in association with dial transmission operation in the key input means, and the control means recognizes the telephone number of the receiving party which is sent out based upon the dial transmission operation, and in response to the specific key operation thereafter, sequentially sends out the telephone number to connect, the password, and the telephone number of the receiving party.

10. The communication apparatus of claim 8, further comprising display means, and
wherein the control means sends out the telephone number of the receiving party and displays the telephone number of the receiving party on the display means.

11. The communication apparatus of claim 9, further comprising display means, and
wherein the control means recognizes the telephone number of the receiving party and displays the telephone number of the receiving party on the display means.

12. The communication apparatus of claim 8, further comprising display means, and
wherein name of the receiving party is stored in the memory means together with telephone number of the receiving party, and the control means sends out the telephone number of the receiving party and displays the telephone number of the receiving party and/or name of the receiving party on the display means.

13. The communication apparatus of claim 9, further comprising display means, and
wherein name of the receiving party is stored in the memory means together with telephone number of the receiving party, and the control means recognizes the telephone number of the receiving party and displays the telephone number of the receiving party and/or name of the receiving party on the display means.

14. The communication apparatus of claim 3, further comprising notice means, and
wherein the control means, when a password is deleted, drives the notice means to give the operator a notice of switching to a new password.

15. The communication apparatus of claim 4, further comprising notice means, and
wherein the control means, when a password is deleted, drives the notice means to give the operator a notice of switching to a new password.

16. The communication apparatus of claim 3, further comprising notice means, and
wherein the control means, when there occurs a case where only one password remains after the deletion of password, drives the notice means to give the operator a notice that only one password remains.

17. The communication apparatus of claim 4, further comprising notice means, and
wherein the control means, when there occurs a case where only one password remains after the deletion of password, drives the notice means to give the operator a notice that only one password remains.

18. The communication apparatus of claim 1, wherein data constellation which is stored in the memory means includes telephone number of the receiving party, and the control means sends out the telephone number of the receiving party after telephone number to connect and password are sent out.

19. A communication system comprising:
a communication apparatus of initiating party;
a communication apparatus of receiving party;
a first communication line network;
a second communication line network; and
a plurality of access points for connecting the first communication line network and the second communication line network, the plurality of access points being able to be connected by the second communication line network,
wherein the communication apparatus of initiating party and the access point, and the communication apparatus of receiving party and the access point are connected by the first communication line network, respectively, and the two access points are connected by the second communication line network so that a communication between the two communication apparatuses is carried out,
wherein when a predetermined password is inputted after connection is established to the access point from the communication apparatus of initiating party, a communication is made available, and
wherein a plurality of passwords can be inputted from the communication apparatus of initiating party to the access point.

20. A communication system comprising:
a communication apparatus of initiating party;
a communication apparatus of receiving party;
a first communication line network;
a second communication line network; and
a plurality of access points for connecting the first communication line network and the second communication line network, the plurality of access points being able to be connected by the second communication line network,
wherein the communication apparatus of initiating party and the access point, and the communication apparatus of receiving party and the access point are connected by the first communication line network, respectively, and the two access points are connected by the second communication line network so that a communication between the two communication apparatuses is carried out,
wherein when a predetermined password is inputted after connection is established to the access point from the communication apparatus of initiating party, a communication is made available, and
wherein when communication possible time by the password which is inputted becomes less than a predetermined threshold value during communication, the access point requires for an input of a password, and in the case where a new password is inputted from the communication apparatus of initiating party, even when the communication possible time by the initial password is expired, the communication is continued based upon the new password without disconnecting the communication.
